(19) United States
(12) Patent Application Publication
(10) Pub. No.: US 2023/0207784 A1
(43) Pub. Date: Jun. 29, 2023

(54) POSITIVE ELECTRODE AND ENERGY STORAGE DEVICE

(71) Applicant: GS Yuasa International Ltd., Kyoto-shi, Kyoto (JP)

(72) Inventors: Kohei TSUJITA, Kyoto (JP); Morito TANABE, Kyoto (JP); Norio YAMATANI, Kyoto (JP)

(21) Appl. No.: 17/928,121

(22) PCT Filed: May 20, 2021
(86) PCT No.: PCT/JP2021/019182

§ 371 Date: Nov. 28, 2022

(30) Foreign Application Priority Data
Jun. 1, 2020 (JP) 2020-095512
Jun. 1, 2020 (JP) 2020- 095523

(51) Int. Cl. H01M 4/36; H01M 4/131; H01M 4/66

(52) U.S. Cl. CPC H01M 4/366; H01M 4/131; H01M 4/663; H01M 2004/028

(57) ABSTRACT

One aspect of the present invention is a positive electrode for an energy storage device including a positive active material layer, in which the positive active material layer includes a positive active material particle having a ratio of a secondary particle size to a primary particle size of 3 or less, and a fibrous conductive agent.

### TECHNICAL FIELD

The present invention relates to a positive electrode and an energy storage device.

### BACKGROUND ART

Nonaqueous electrolyte secondary batteries typified by lithium ion secondary batteries are widely used for electronic devices such as personal computers and communication terminals, motor vehicles, and the like since these secondary batteries have a high energy density. The nonaqueous electrolyte secondary batteries generally include a pair of electrodes, which are electrically separated from each other by a separator, and a nonaqueous electrolyte interposed between the electrodes, and are configured to allow ions to be transferred between the two electrodes for charge-discharge. Also, capacitors such as lithium ion capacitors and electric double-layer capacitors, energy storage devices using electrolytes other than nonaqueous electrolyte and the like are also widely used as energy storage devices other than nonaqueous electrolyte secondary batteries.

As a positive active material used in the energy storage device, a positive active material of a secondary particle formed by aggregation of primary particles and a positive active material of a single particle in a state in which primary particles are dispersed without being aggregated are known. As a single-particle positive active material, Patent Document 1 describes the invention of a positive active material for a nonaqueous secondary battery which is a powder lithium composite oxide of monodispersed primary particles containing one element selected from the group consisting of Co, Ni and Mn, and lithium as main components.

### PRIOR ART DOCUMENT

### Patent Document

Patent Document 1: JP-A-2004-355824

### SUMMARY OF THE INVENTION

### Problems to be Solved by the Invention

As compared with a positive active material particle which is a secondary particle formed by aggregation of a large number of primary particles, a positive active material particle existing in a state of substantially non-aggregated primary particles and a positive active material particle which is a secondary particle formed by aggregation of a relatively small number of primary particles have less grain boundaries, and therefore cracking and the like hardly occur. For this reason, the energy storage device using these particles has an advantage that a decrease in capacity associated with a charge-discharge cycle is small, and the like. Hereinafter, a “positive active material particle existing in a state of substantially non-aggregated primary particles or a positive active material particle which is a secondary particle formed by aggregation of a relatively small number of primary particles” is also referred to as a “single-particle-based positive active material particle”. However, a positive electrode and an energy storage device in which the single-particle-based positive active material particle is used may have high initial DC resistance.

The present invention has been made in view of the above circumstances, and an object of the present invention is to provide a positive electrode for an energy storage device including a single-particle-based positive active material particle, the positive electrode with reduced initial DC resistance, and an energy storage device including the positive electrode.

### Means for Solving the Problems

One aspect of the present invention is a positive electrode (A) for an energy storage device including a positive active material layer, in which the positive active material layer includes a positive active material particle having a ratio of a secondary particle size to a primary particle size of 3 or less, and a fibrous conductive agent.

Another aspect of the present invention is a positive electrode (B) for an energy storage device including a positive active material layer, in which the positive active material layer includes a positive active material particle existing in a state of substantially non-aggregated primary particles, and a fibrous conductive agent.

Another aspect of the present invention is an energy storage device including the positive electrode (A) and the positive electrode (B).

### Advantages of the Invention

According to one aspect of the present invention, it is possible to provide a positive electrode for an energy storage device including a single-particle-based positive active material particle, the positive electrode with reduced initial DC resistance, and an energy storage device including the positive electrode.

### BRIEF DESCRIPTION OF THE DRAWINGS

FIG. 1 is an external perspective view showing an energy storage device according to an embodiment of the present invention.

FIG. 2 is a schematic view illustrating an energy storage apparatus configured by aggregating a plurality of energy storage devices according to an embodiment of the present invention.

### MODE FOR CARRYING OUT THE INVENTION

First, outlines of a positive electrode and an energy storage device disclosed in the present specification will be described.

A positive electrode according to one aspect of the present invention is a positive electrode (A) for an energy storage device including a positive active material layer, in which the positive active material layer includes a positive active material particle having a ratio of a secondary particle size to a primary particle size of 3 or less, and a fibrous conductive agent.

The positive electrode (A) is a positive electrode for an energy storage device including a positive active material particle having a ratio of a secondary particle size to a primary particle size of 3 or less which is a single-particle-based positive active material particle, and initial DC resistance is reduced. Although the reason therefor is not clear, the following reason is presumed. When the single-particle-based positive active material particle is used in combination with a particulate conductive agent such as general carbon black as a conductive agent, the positive active material particle and the particulate conductive agent are in point contact with each other, and the contact area is small, so that an isolated positive active material particle is likely to exist without being in contact with the conductive agent. On the other hand, when the single-particle-based positive active material particle is used in combination with a fibrous conductive agent, the fibrous conductive agent can be deformed to follow a surface shape of the single-particle-based positive active material particle with relatively few irregularities. Therefore, in the positive electrode (A), it is presumed that conductivity between the single-particle-based positive active material particles is sufficiently secured, and the initial DC resistance is reduced.

The “primary particle size” of the positive active material particle refers to an average value of particle sizes of arbitrary fifty primary particles constituting the positive active material particle observed by a scanning electron microscope (SEM). The primary particle is a particle in which no grain boundary is observed in appearance in the observation with the SEM. The particle size of the primary particle is determined as follows. The shortest diameter passing through the center of the minimum circumscribed circle of the primary particle is defined as a minor axis, and the diameter passing through the center and orthogonal to the minor axis is defined as a major axis. The average value of the major axis and the minor axis is defined as the particle size. When there are two or more shortest diameters, a shortest diameter with the longest orthogonal diameter is defined as a minor axis.

The “secondary particle size” of the positive active material particle refers to a value at which a volume-based integrated distribution calculated in accordance with JIS-Z-8819-2 (2001) is 50% (D50: median size) based on a particle size distribution measured by a laser diffraction/scattering method for a diluted solution obtained by diluting positive active material particles with a solvent in accordance with JIS-Z-8815 (2013).

The “fibrous conductive agent” refers to a conductive agent with a deformable elongated shape. The ratio of the length to the diameter of the fibrous conductive agent is, for example, 10 or more. The diameter and length of the fibrous conductive agent are based on an SEM image or a transmission electron microscope (TEM) image of the positive active material layer as viewed in a normal direction (plan view).

A positive electrode according to another aspect of the present invention is a positive electrode (B) for an energy storage device including a positive active material layer, in which the positive active material layer includes a positive active material particle existing in a state of substantially non-aggregated primary particles, and a fibrous conductive agent.

The positive electrode (B) is a positive electrode for an energy storage device including a positive active material particle existing in a state of substantially non-aggregated primary particles which is a single-particle-based positive active material particle, and initial DC resistance is reduced. Although the reason therefor is not clear, the same reason as that of the positive electrode (A) described above is presumed.

The positive active material particle “existing in a state of substantially non-aggregated primary particles” means that when the positive active material layer is observed by SEM, or when the positive active material particle is collected from the positive active material layer and the positive active material particle is observed by SEM in a state where a binder is removed, a plurality of primary particles exist independently without being aggregated, or that the primary particle and other primary particle are generally not directly bonded.

In the positive electrode (A) and the positive electrode (B), the positive active material layer preferably further includes a granular conductive agent. When the positive active material layer further includes the granular conductive agent, a DC resistance increase rate associated with a charge-discharge cycle is reduced. Although the reason therefor is not clear, the following reason is presumed. When only a granular conductive agent such as general carbon black is used as a conductive agent for a single-particle-based positive active material particle, the positive active material particle and the granular conductive agent are in point contact with each other, and the contact area is small, so that an isolated positive active material particle is likely to exist without being in contact with the conductive agent. Therefore, in such a case, it is considered that an increase in DC resistance associated with a charge-discharge cycle increases. On the other hand, when the fibrous conductive agent is used for the single-particle-based positive active material particle, the fibrous conductive agent can be deformed to follow a surface shape of the single-particle-based positive active material particle with relatively few irregularities, so that the contact area between the positive active material particle and the conductive agent increases. However, the fibrous conductive agent has a small volume, thus, when only the fibrous conductive agent is used as the conductive agent, a void is likely to be generated between the positive active material particles in which expansion and contraction occur associated with the charge-discharge cycle, and it is difficult to sufficiently maintain the conductivity of the positive active material layer. Therefore, by using the fibrous conductive agent and the granular conductive agent in combination, it is possible to bring the single-particle-based positive active material particle into sufficient contact with the conductive agent, and to sufficiently fill the void between the positive active material particles. From the above, in the positive electrode (A) and the positive electrode (B), it is presumed that the conductivity of the positive active material layer is sufficiently maintained even after the charge-discharge cycle, and the DC resistance increase rate associated with a charge-discharge cycle is reduced.

The “granular conductive agent” refers to a granular conductive agent. The ratio of the major axis to the minor axis of the granular conductive agent is, for example, 1 or more and less than 10. The minor axis and major axis of the granular conductive agent are based on an SEM or TEM image of the positive active material layer as viewed in a normal direction (plan view). The shortest diameter passing through the center of the minimum circumscribed circle of the granular conductive agent is defined as a minor axis, and the diameter passing through the center and orthogonal to the minor axis is defined as a major axis. When there are two or more shortest diameters, a shortest diameter with the longest orthogonal diameter is defined as a minor axis. The granular conductive agent may be a granular conductive agent that is not substantially deformed.

In the positive electrode (A) and the positive electrode (B), the fibrous conductive agent and the granular conductive agent are preferably carbonaceous materials. By using such a fibrous conductive agent and granular conductive agent, the DC resistance increase rate associated with a charge-discharge cycle can be further reduced.

The carbonaceous material refers to a material in which the main component (element having the largest content on a mass basis) is carbon. The content of carbon in the carbonaceous material is, for example, 70% by mass or more, preferably 90% by mass or more, and more preferably 95% by mass or more. Examples of an element other than carbon that may be contained in the carbonaceous material include oxygen and hydrogen.

In the positive electrode (A) and the positive electrode (B), the average diameter of the fibrous conductive agent is preferably 100 nm or less. When the average diameter of the fibrous conductive agent is 100 nm or less, the initial DC resistance and the DC resistance increase rate associated with a charge-discharge cycle are further reduced. As a reason for this, it is presumed that in the case of a sufficiently thin fibrous conductive agent having an average diameter of 100 nm or less, since the fibrous conductive agent is easily deformed particularly following the surface shape of the positive active material particle, a conductive path connecting the positive active material particles is easily formed. A plurality of the fibrous conductive agents may be bundled.

The “average diameter” of the fibrous conductive agent refers to an average value of diameters of arbitrary ten fibrous conductive agents observed by SEM or transmission electron microscope (TEM).

In the positive electrode (A) and the positive electrode (B), the content of the fibrous conductive agent in the positive active material layer is preferably 3% by mass or less. By using a relatively small amount of the fibrous conductive agent as described above, it is possible to secure a high energy density while sufficiently reducing the initial DC resistance. In addition, by setting the content of the fibrous conductive agent to 3% by mass or less, stability of the positive composite paste during production is increased, and production cost can also be suppressed.

In the positive electrode (A) and the positive electrode (B), the content of the fibrous conductive agent with respect to a total content of the fibrous conductive agent and the granular conductive agent in the positive active material layer is preferably 30% by mass or more and 70% by mass or less. When the content of the fibrous conductive agent with respect to the total content of the fibrous conductive agent and the granular conductive agent is within the above range, a mixing ratio of the fibrous conductive agent and the granular conductive agent is optimized, and the conductivity of the positive active material layer is improved. As a result, the DC resistance increase rate associated with a charge-discharge cycle is further reduced.

In the positive electrode (A) and the positive electrode (B), the positive active material particle is preferably a lithium transition metal composite oxide having an α-NaFeO₂-type crystal structure. In the lithium transition metal composite oxide having an α-NaFeO₂-type crystal structure, for example, as compared with a lithium transition metal composite oxide having a spinel-type crystal structure, elution of a transition metal such as manganese associated with a charge-discharge cycle hardly occurs, so that the DC resistance increase rate associated with a charge-discharge cycle is further reduced.

An energy storage device according to one aspect of the present invention is an energy storage device including the positive electrode (A) or the positive electrode (B). In the energy storage device, initial DC resistance is reduced. Therefore, the energy storage device can also be suitably applied to high-power applications.

Hereinafter, a positive electrode and an energy storage device according to an embodiment of the present invention will be described in order.

<Positive Electrode>

The positive electrode according to an embodiment of the present invention includes a positive electrode substrate and a positive active material layer stacked on the positive electrode substrate directly or with an intermediate layer interposed therebetween. The positive electrode is a positive electrode for an energy storage device.

The positive electrode substrate has conductivity. Having “conductivity” means having a volume resistivity of 10⁷ S2 cm or less that is measured in accordance with JIS-H-0505 (1975), and the term “non-conductivity” means that the volume resistivity is more than 10⁷ Ω-cm. As the material of the positive electrode substrate, a metal such as aluminum, titanium, tantalum or stainless steel, or an alloy thereof is used. Among these materials, aluminum and an aluminum alloy are preferable from the viewpoint of electric potential resistance, high conductivity, and costs. Also, examples of the positive electrode substrate include a foil, a deposited film, a mesh, and a porous material, and a foil is preferable from the viewpoint of costs. Namely, the positive electrode substrate is preferably an aluminum foil or an aluminum alloy foil. Examples of the aluminum or aluminum alloy include A1085, A3003, A1N30, and the like specified in JIS-H-4000 (2014) or JIS-H-4160 (2006).

The average thickness of the positive electrode substrate is preferably 3 μm or more and 50 μm or less, more preferably 5 μm or more and 40 μm or less, still more preferably 8 μm or more and 30 μm or less, and particularly preferably 10 μm or more and 25 μm or less. By setting the average thickness of the positive electrode substrate within the above-described range, it is possible to enhance the energy density per volume of the energy storage device while increasing the strength of the positive electrode substrate. The “average thickness” of the positive electrode substrate and the negative electrode substrate described below refers to a value obtained by dividing a cutout mass in cutout of a substrate having a predetermined area by a true density and a cutout area of the substrate.

The intermediate layer is a coating layer on the surface of the positive electrode substrate, and contains conductive particles such as carbon particles to reduce contact resistance between the positive electrode substrate and the positive active material layer. The configuration of the intermediate layer is not particularly limited, and includes, for example, a binder and a conductive agent.

The positive active material layer is formed of a so-called positive composite containing a positive active material particle and a fibrous conductive agent. The positive composite forming the positive active material layer preferably further includes a granular conductive agent. The positive composite forming the positive active material layer further contains optional components such as a binder, a thickener, a filler, or the like as necessary.

In an embodiment of the present invention, as the positive active material particle, a positive active material particle α having a ratio of a secondary particle size to a primary particle size of 3 or less is used. The ratio of a secondary particle size to a primary particle size is preferably 2 or less, more preferably 1.5 or less, and further preferably 1.2 or less. When the ratio of a secondary particle size to a primary particle size of the positive active material particle α is equal to or less than the above upper limit, it is possible to sufficiently exhibit an advantage of the single-particle-based positive active material particle that cracking and the like hardly occur and a capacity retention ratio is high.

The lower limit of the ratio of a secondary particle size to a primary particle size of the positive active material particle α may be 1. From a difference between a method for measuring a primary particle size and a method for measuring a secondary particle size, the lower limit of the ratio of a secondary particle size to a primary particle size of the positive active material particle α may be less than 1, for example, 0.9.

In another embodiment of the present invention, as the positive active material particle, a positive active material particle β existing in a state of substantially non-aggregated primary particles is used. Even in such a case, it is possible to sufficiently exhibit the advantage of the single-particle-based positive active material particle that cracking and the like hardly occur and a capacity retention ratio is high. For example, in arbitrary fifty positive active material particles observed in the SEM, the number of positive active material particles composed of one independent primary particle, that is, single particles, is preferably more than twenty five, more preferably thirty or more, and further preferably forty or more.

The primary particle size of the positive active material particle a and the primary particle size of the positive active material particle β (that is, the particle size of the positive active material particle β) are, for example, preferably 0.1 μm or more and 10 μm or less, more preferably 0.5 μm or more and 8 μm or less, further preferably 1 μm or more and 6 μm or less, and even more preferably 2 μm or more and 5 μm or less. The secondary particle size of the positive active material particle α is, for example, preferably 0.1 μm or more and 10 μm or less, more preferably 0.5 μm or more and 8 μm or less, further preferably 1 μm or more and 6 μm or less, and even more preferably 2 μm or more and 5 μm or less. By setting these particle sizes (primary particle size and secondary particle size) within the above ranges, the conductivity of the positive active material layer is improved, the initial DC resistance is further reduced, and the DC resistance increase rate associated with a charge-discharge cycle tends to be further reduced.

The positive active material particle may contain other positive active material particle other than the positive active material particle a and the positive active material particle β. However, the content of the positive active material particles α or the positive active material particles β with respect to all the positive active material particles included in the positive active material layer is preferably 80% by mass or more, more preferably 90% by mass or more, further preferably 99% by mass or more, and even more preferably substantially 100% by mass. That is, in the positive electrode, it is particularly preferable to use only the positive active material particle α or the positive active material particle β as the positive active material particle. As a result, the advantage of using the single-particle-based positive active material particle in the positive electrode is particularly sufficiently exhibited.

The single-particle-based positive active material particle having a predetermined particle size can be produced by a known method, and the primary particle size and the like can be controlled by production conditions. As the single-particle-based positive active material particle having a predetermined particle size, a commercially available product may be used. In the process of producing the active material, a plurality of primary particles can be grown to increase the particle size by increasing firing temperature or prolonging firing time. Alternatively, the primary particle can be formed by crushing the secondary particle.

The material (type) of the positive active material constituting the positive active material particle can be appropriately selected from known positive active materials. As the positive active material for a lithium ion secondary battery, a material capable of storing and releasing lithium ions is usually used. Examples of the positive active material include lithium transition metal composite oxides having an α-NaFeO₂-type crystal structure, lithium transition metal composite oxides having a spinel-type crystal structure, polyanion compounds, chalcogenides, and sulfur. Examples of the lithium transition metal composite oxide having an α-NaFeO₂ type crystal structure include Li[LiₓNi₁₋ₓ]O₂ (0≤x<0.5), Li[LiₓNi_{Y}Co_{(1-x-Y})]O₂ (0≤x<0.5, 0<Y<1), Li[LiₓCo₍₁₋ₓ₎]O₂ (0≤x<0.5), Li[LiₓNi_{Y}Mn_{(1-x-y)}]O₂ (0≤x<0.5, 0<Y<1), Li[LiₓNi_{Y}Mn_{β}Co_{(1-x-y-β)}]O₂ (0≤x<0.5, 0<Y, 0<β, 0.5<y+β<1), and Li[LiₓNi_{Y}Co_{β}Al_{(1-x-Y-β)}]O₂ (0≤x<0.5, 0<Y, 0<β, 0.5<Y+β<1). Examples of the lithium transition metal composite oxides having a spinel-type crystal structure include LiₓMn₂O₄ and LiₓNi_{Y}Mn_{(2-y)}O₄. Examples of the polyanion compounds include LiFePO₄, LiMnPO₄, LiNiPO₄, LiCoPO₄, Li₃V₂(PO₄)₃, Li₂MnSiO₄, and Li₂CoPO₄F. Examples of the chalcogenides include titanium disulfide, molybdenum disulfide, and molybdenum dioxide. Some of atoms or polyanions in these materials may be substituted with atoms or anion species composed of other elements.

As the positive active material, a lithium transition metal composite oxide is preferable, a lithium transition metal composite oxide containing nickel, cobalt, and manganese or aluminum is more preferable, and a lithium transition metal composite oxide containing nickel, cobalt, and manganese is still more preferable. The lithium transition metal composite oxide preferably has an α-NaFeO₂-type crystal structure. By using such a lithium transition metal composite oxide, the energy density can be increased, and the like. Since the lithium transition metal composite oxide has an α-NaFeO₂-type crystal structure, elution of a transition metal such as manganese associated with a charge-discharge cycle hardly occurs as compared with a spinel-type crystal structure and the like, so that the DC resistance increase rate associated with a charge-discharge cycle is further reduced. In addition, these positive active materials are generally produced and often used in the form of a secondary particle formed by aggregation of a large number of primary particles. Therefore, in an embodiment of the present invention, by using these positive active materials for the single-particle-based positive active material particle, in addition to the advantages of the high energy density and the like of these positive active materials, it is possible to exhibit a good function having a high capacity retention ratio due to the single-particle-based particle and a low initial DC resistance due to use in combination with the fibrous conductive agent.

As the lithium transition metal composite oxide having an α-NaFeO₂-type crystal structure, a compound represented by the following formula (1) is preferable.

Li_{1+α}Me_{1-α}O₂ (1)

In the formula (1), Me is a metal (excluding Li) containing Ni, Co, and Mn or Al. The condition of 0≤α<1 is met.

Me in the formula (1) is preferably substantially composed of three elements of Ni, Co and Mn, or three elements of Ni, Co and Al, and more preferably composed of three elements of Ni, Co and Mn. However, Me may contain other metals.

From the viewpoint of further increasing electric capacity and the like, a preferred content (composition ratio) of each constituent element in the compound represented by the formula (1) is as follows. The molar ratio is equal to the atomic number ratio.

In the formula (1), the lower limit of the molar ratio (Ni/Me) of Ni to Me is preferably 0.1, and more preferably 0.2, 0.3 or 0.4 in some cases. On the other hand, the upper limit of this molar ratio (Ni/Me) is preferably 0.9, and more preferably 0.8, 0.7 or 0.6 in some cases.

In the formula (1), the lower limit of the molar ratio of Co to Me (Co/Me) is preferably 0.01, and more preferably 0.1 or 0.2 in some cases. On the other hand, the upper limit of the molar ratio (Co/Me) is preferably 0.5, and more preferably 0.4 or 0.3 in some cases.

In the formula (1), the lower limit of the molar ratio of Mn to Me (Mn/Me) may be 0, and is preferably 0.05, and more preferably 0.1 or 0.2 in some cases. On the other hand, the upper limit of the molar ratio (Mn/Me) is preferably 0.6, and more preferably 0.4 or 0.3 in some cases.

In the formula (1), the lower limit of the molar ratio of Al to Me (Al/Me) may be 0, and is preferably 0.01, and more preferably 0.02 or 0.03 in some cases. On the other hand, the upper limit of the molar ratio (Al/Me) is preferably 0.3, and more preferably 0.2 or 0.1 in some cases.

In the formula (1), the molar ratio (Li/Me) of Li to Me, that is, (1+α)/(1−α), may be 1, and is more than 1.0 (α>0) or 1.1 or more in some cases. On the other hand, the upper limit of the molar ratio (Li/Me) is preferably 1.6, and more preferably 1.4 or 1.2 in some cases.

A composition ratio of the lithium transition metal composite oxide refers to a composition ratio when a completely discharged state is provided by the following method. First, the energy storage device is subjected to constant current charge with a current of 0.05 C until the voltage becomes an end-of-charge voltage under normal usage, so that the energy storage device is brought to a fully charged state. After a 30-minute pause, the nonaqueous electrolyte energy storage device is subjected to constant current discharge with a current of 0.05 C to the lower limit voltage during normal usage. After the battery is disassembled to take out the positive electrode, a test battery using a metal lithium electrode as the counter electrode is assembled, constant current discharge is performed at a current value of 10 mA per 1 g of a positive active material until the positive potential reaches 2.0 V vs. Li/Li⁺, and the positive electrode is adjusted to the completely discharged state. The battery is disassembled again, and the positive electrode is taken out. A nonaqueous electrolyte attached onto the taken out positive electrode is sufficiently washed with dimethyl carbonate and is dried at room temperature for an entire day and night, and the lithium transition metal composite oxide of the positive active material is then collected. The collected lithium transition metal composite oxide is subjected to measurement. Operations from disassembly to measurement of the energy storage device are performed in an argon atmosphere having a dew point of −60° C. or lower. The “during normal usage” herein means use of the energy storage device while employing charge-discharge conditions recommended or specified in the energy storage device, and when a charger is prepared for the energy storage device, this term means use of the energy storage device by applying the charger.

Examples of suitable lithium transition metal composite oxides include LiNi_{1/3}Co_{1/3}Mn_{1/3}O₂, LiNi_{3/5}Co_{1/5}Mn_{1/5}Mn_{1/5}O₂, LiNi_{1/2}Co_{1/5}Mn_{3/10}O₂, LiNi_{1/2}Co_{3/10}Mn_{1/5}O₂, LiNi_{8/10}Co_{1/10}Mn_{1/10}O₂, and LiNi_{0.8}Co_{0.15}Al_{0.05}O₂.

The material of the positive active material may be used singly, or two or more thereof may be used in mixture. Among them, the positive active material preferably contains the lithium transition metal composite oxide in a proportion of 50% by mass or more (preferably 70 to 100% by mass, more preferably 80 to 100% by mass) of all the positive active materials to be used, and it is more preferable to use a positive active material substantially composed only of the lithium metal composite oxide.

The content of the positive active material particle in the positive active material layer is preferably 80% by mass or more and 99% by mass or less, more preferably 85% by mass or more and 98% by mass or less, and even more preferably 90% by mass or more and 97% by mass or less. By setting the content of the positive active material particle in the positive active material layer within the above range, the conductivity and energy density of the positive active material layer can be enhanced in a well-balanced manner.

The fibrous conductive agent is a component that functions as a conductive agent in the positive active material layer. Examples of the fibrous conductive agent include fibrous metal, a fibrous conductive resin, and fibrous carbon, and fibrous carbon is preferable. The fibrous carbon is not particularly limited as long as it is a fibrous carbon material. Examples of the fibrous carbon (fibrous conductive agent that is a carbonaceous material) include carbon nanofibers, pitch-based carbon fibers, and carbon nanotubes (CNT), and CNT which is graphene-based carbon can be suitably used.

The average diameter of the fibrous conductive agent may be, for example, 1 nm or more and 300 nm or less, but is preferably 3 nm or more and 100 nm or less, more preferably 5 nm or more and 50 nm or less, and even more preferably 10 nm or more and 30 nm or less. When the average diameter of the fibrous conductive agent is within the above range, the conductivity of the positive active material layer is further improved, and the initial DC resistance and the DC resistance increase rate associated with a charge-discharge cycle are further reduced.

The average aspect ratio (ratio of the average length to the average diameter) of the fibrous conductive agent is, for example, preferably 10 or more and 10,000 or less, more preferably 100 or more, and further preferably 1,000 or more. By using the fibrous conductive agent having an average aspect ratio in the above range, better conductivity of the positive active material layer can be exhibited. The “average length” of the fibrous conductive agent refers to an average value of lengths of arbitrary ten fibrous conductive agents observed by SEM or TEM. When the average aspect ratio is calculated, it is preferable that the ten fibrous conductive agents for determining the average diameter and the ten fibrous conductive agents for determining the average length are the same particles, but the average diameter and the average length may be determined for ten different particles, and the ratio may be taken as the average aspect ratio. That is, the average aspect ratio of the fibrous conductive agent refers to an average value of aspect ratios (lengths to diameters) of arbitrary ten fibrous conductive agents observed by SEM or TEM, or a ratio of an average length of arbitrary ten different fibrous conductive agents to an average diameter of arbitrary ten fibrous conductive agents observed by SEM or TEM.

When the fibrous conductive agent is fibrous carbon, average lattice spacing (d₀₀₂) of a (002) plane determined by X-ray diffraction of the fibrous carbon is preferably less than 0.340 nm. When the average lattice spacing (d₀₀₂) of the fibrous carbon is small and the crystallinity is high as described above, the conductivity of the positive active material layer is further enhanced. The lower limit of the average lattice spacing (d₀₀₂) of the fibrous carbon can be set to, for example, 0.330 nm. Also, full width at half maximum (002) of a peak corresponding to the (002) plane of the fibrous carbon measured by an X-ray diffraction method is, for example, 0.5° or more. The full width at half maximum (002) of the fibrous carbon is preferably less than 0.7°.

The fibrous carbon can be obtained by, for example, a method in which a polymer is formed into a fibrous form by a spinning method or the like and heat-treated in an inert atmosphere, a vapor phase growth method in which an organic compound is reacted at a high temperature in the presence of a catalyst, or the like. As the fibrous carbon, fibrous carbon obtained by a vapor phase growth method (vapor phase growth method fibrous carbon) is preferable. Commercially available fibrous carbon and other fibrous conductive agents can be used.

The content of the fibrous conductive agent in the positive active material layer may be, for example, 0.05% by mass or more and 5% by mass or less, but is preferably 0.1% by mass or more and 3% by mass or less, more preferably 0.3% by mass or more and 1% by mass or less, and further preferably 0.6% by mass or less in some cases. By setting the content of the fibrous conductive agent to be equal to or greater than the above lower limit, it is possible to further enhance the conductivity of the positive active material layer and further reduce the initial DC resistance. On the other hand, by setting the content of the fibrous conductive agent to be equal to or less than the above upper limit, it is possible to relatively increase the content of the positive active material particle and increase the energy density while sufficiently reducing the initial DC resistance. In addition, by setting the content of the fibrous conductive agent to be equal to or less than the above upper limit, the production cost can also be suppressed. From the viewpoint of further reducing the DC resistance increase rate associated with a charge-discharge cycle, the content of the fibrous conductive agent is preferably 0.5% by mass or more and 3% by mass or less, more preferably 1% by mass or more and 2.5% by mass or less, and may be further preferably 1.4% by mass or more or 1.7% by mass or more.

The content of the fibrous conductive agent with respect to the total content of the fibrous conductive agent and the granular conductive agent in the positive active material layer is preferably 5% by mass or more and 90% by mass or less, more preferably 10% by mass or more and 80% by mass or less, further preferably 15% by mass or more and 70% by mass or less, and even more preferably 20% by mass or more and 60% by mass or less. When the content of the fibrous conductive agent with respect to the total content of the fibrous conductive agent and the granular conductive agent is within the above range, a mixing ratio of the fibrous conductive agent and the granular conductive agent is optimized, and the conductivity of the positive active material layer is improved. As a result, the DC resistance increase rate associated with a charge-discharge cycle is further reduced.

Examples of the granular conductive agent include granular metal, a granular conductive resin, a granular conductive ceramic, and granular carbon, and granular carbon is preferable. The granular carbon refers to a granular conductive agent that is a carbonaceous material. Examples of the granular carbon (granular conductive agent that is a carbonaceous material) include graphitized carbon, non-graphitized carbon, and graphene-based carbon. Examples of the non-graphitized carbon include carbon black. Examples of the carbon black include furnace black, acetylene black, and ketjen black. Examples of the graphene-based carbon include graphene and fullerene. Among them, non-graphitized carbon is preferable, and carbon black is more preferable.

The granular conductive agent is composed of primary particles, and the primary particle preferably exists in an aggregated state. The average particle size of the primary particles of the granular conductive agent is, for example, 10 nm or more and 500 nm or less, and more preferably 20 nm or more and 100 nm or less. By using the granular conductive agent having such a size, it is possible to effectively fill the void between the positive active material particles and further enhance the conductivity of the positive active material layer The “average particle size” of the granular conductive agent refers to an average value of the particle size of arbitrary ten granular conductive agents observed by SEM or TEM. The particle size of the granular conductive agent is an average value of a major axis and a minor axis.

The average aspect ratio of the granular conductive agent may be, for example, 1 or more and less than 10, and is preferably 6 or less, 3 or less, 2 or less, or 1.5 or less. By using the granular conductive agent having a relatively nearly spherical shape, it is possible to effectively fill the void between the positive active material particles and further enhance the conductivity of the positive active material layer The average aspect ratio of the granular conductive agent is an average value of aspect ratios (ratio of the major axis to the minor axis) of arbitrary ten granular conductive agents observed by SEM or TEM. Also, when the granular conductive agent exists in a state where the primary particles are aggregated, the average aspect ratio of the granular conductive agent is defined as a value of the primary particle.

The content of the granular conductive agent in the positive active material layer may be, for example, 0.1% by mass or more and 10% by mass or less, but is preferably 0.5% by mass or more and 6% by mass or less, more preferably 1% by mass or more and 5% by mass or less, and further preferably 2% by mass or more and 4% by mass or less in some cases. By setting the content of the granular conductive agent to be equal to or greater than the above lower limit, it is possible to further enhance the conductivity of the positive active material layer and further reduce the DC resistance increase rate associated with a charge-discharge cycle. On the other hand, by setting the content of the granular conductive agent to be equal to or less than the above upper limit, it is possible to relatively increase the content of the positive active material particle and increase the energy density while sufficiently reducing the DC resistance increase rate associated with a charge-discharge cycle.

The total content of the fibrous conductive agent and the granular conductive agent in the positive active material layer is preferably 0.3% by mass or more and 10% by mass or less, more preferably 1% by mass or more and 8% by mass or less, further preferably 2% by mass or more and 6% by mass or less, and even more preferably 3% by mass or more and 5% by mass or less. By setting the total content of the fibrous conductive agent and the granular conductive agent in the positive active material layer to be equal to or greater than the above lower limit, it is possible to further enhance the conductivity of the positive active material layer and further reduce the DC resistance increase rate associated with a charge-discharge cycle. On the other hand, by setting the total content of the fibrous conductive agent and the granular conductive agent to be equal to or less than the above upper limit, it is possible to relatively increase the content of the positive active material particles and increase the energy density while sufficiently reducing the DC resistance increase rate associated with a charge-discharge cycle.

The positive active material layer may include a conductive agent other than the fibrous conductive agent and the granular conductive agent. However, the conductive agent in the positive active material layer is preferably substantially composed of the fibrous conductive agent and the granular conductive agent. For example, the contents of the fibrous conductive agent and the granular conductive agent with respect to all the conductive agents in the positive active material layer are preferably 90% by mass or more, and further preferably 99% by mass or more.

The content of all the conductive agents (fibrous conductive agent, granular conductive agent, and other conductive agents) in the positive active material layer in the positive active material layer is, for example, preferably 0.3% by mass or more and 10% by mass or less, preferably 1% by mass or more and 8% by mass or less, and more preferably 2% by mass or more and 6% by mass or less. By setting the content of all the conductive agents in the positive active material layer to be equal to or greater than the above lower limit, it is possible to further enhance the conductivity of the positive active material layer and further reduce the initial DC resistance and the DC resistance increase rate associated with a charge-discharge cycle. On the other hand, by setting the content of all the conductive agents to be equal to or less than the above upper limit, it is possible to relatively increase the content of the positive active material particle and increase the energy density while sufficiently reducing the DC resistance increase rate associated with a charge-discharge cycle.

Examples of the binder include a solvent-based binder and an aqueous binder, and a solvent-based binder is preferable. The solvent-based binder refers to a binder that is dispersed or dissolved in an organic solvent.

Examples of the solvent-based binder include thermoplastic resins such as fluororesins (polytetrafluoroethylene (PTFE), polyvinylidene fluoride (PVDF), and the like), polyethylene, polypropylene, and polyimide, copolymers of vinylidene fluoride and hexafluoropropylene, copolymers of ethylene and vinyl alcohol, polyacrylonitrile, polyphosphazene, polysiloxane, polyvinyl acetate, polymethyl methacrylate, polystyrene, polycarbonate, polyamide, polyamideimide, crosslinked polymers of cellulose and chitosan pyrrolidone carboxylate, and derivatives of chitin or chitosan, and fluororesins are preferable, and PVDF is more preferable. One or two or more of the solvent-based binders can be used.

The content of the binder in the positive active material layer is preferably 0.3% by mass or more and 10% by mass or less, more preferably 0.5% by mass or more and 8% by mass or less, and further preferably 5% by mass or less in some cases. By setting the content of the binder to be equal to or greater than the above lower limit, the active material can be stably held. In addition, by setting the content of the binder to be equal to or less than the above upper limit, it is possible to increase the content of the positive active material particles and increase the energy density.

Examples of the thickener include polysaccharide polymers such as carboxymethylcellulose (CMC) and methylcellulose. Also, when the thickener includes a functional group that is reactive with lithium, it is preferable to deactivate this functional group by methylation and the like in advance. In the case of using a thickener, the content of the thickener in the positive active material layer is preferably 5% by mass or less, and further preferably 1% by mass or less. The technique disclosed herein can be preferably carried out in an aspect in which the positive active material layer does not contain a thickener.

The filler is not particularly limited. Examples of the filler include polyolefins such as polypropylene and polyethylene, inorganic oxides such as silicon dioxide, aluminum oxide, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, barium sulfate and the like, nitrides such as aluminum nitride and silicon nitride, and substances derived from mineral resources, such as talc, montmorillonite, boehmite, zeolite, apatite, kaolin, mullite, spinel, olivine, sericite, bentonite and mica, and artificial products thereof. In the case of using a filler, the content of the filler in the positive active material layer is preferably 5% by mass or less, and further preferably 1% by mass or less. The technique disclosed herein can be preferably carried out in an aspect in which the positive active material layer does not contain a filler.

The positive active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Nb, or W as a component other than the positive active material particle, the conductive agent, the binder, the thickener, and the filler.

The positive electrode can be produced, for example, by applying a positive composite paste to a positive electrode substrate directly or via an intermediate layer, followed by drying. The positive composite paste contains components constituting the positive active material layer, such as a positive active material particle and a fibrous conductive agent, and a granular conductive agent and a binder as optional components. The positive composite paste usually further contains a dispersion medium. As described above, an organic solvent is suitably used as the dispersion medium. Examples of the organic solvent that is a dispersion medium used for preparing the positive composite paste include N-methylpyrrolidone (NMP) and toluene.

<Energy Storage Device>

The energy storage device according to one embodiment of the present invention has a positive electrode, a negative electrode, and an electrolyte. Hereinafter, a nonaqueous electrolyte secondary battery (hereinafter, also simply referred to as a “secondary battery”) will be described as an example of the energy storage device. The positive electrode and the negative electrode usually form an electrode assembly alternately superposed by stacking or winding with a separator interposed therebetween. The electrode assembly is housed in a case, and the case is filled with the nonaqueous electrolyte. The nonaqueous electrolyte is interposed between the positive electrode and the negative electrode. As the case, a known metal case, a resin case or the like, which is usually used as a case of a secondary battery, can be used.

(Positive Electrode)

The positive electrode provided in the secondary battery is the above-described positive electrode according to one embodiment of the present invention.

(Negative Electrode)

The negative electrode has a negative electrode substrate and a negative active material layer stacked directly or via an intermediate layer on the negative electrode substrate. The intermediate layer may have the same configuration as the intermediate layer of the positive electrode.

Although the negative electrode substrate may have the same configuration as the positive electrode substrate, as the material of the negative electrode substrate, metals such as copper, nickel, stainless steel, and nickel-plated steel, and aluminum or alloys thereof, and carbonaceous materials are used. Among these metals and alloys, copper or a copper alloy is preferable. Examples of the negative electrode substrate include a foil, a deposited film, a mesh, and a porous material, and a foil is preferable from the viewpoint of costs. Therefore, the negative electrode substrate is preferably a copper foil or a copper alloy foil. Examples of the copper foil include a rolled copper foil and an electrolytic copper foil.

The average thickness of the negative electrode substrate is preferably 2 μm or more and 35 μm or less, more preferably 3 μm or more and 30 μm or less, still more preferably 4 μm or more and 25 μm or less, and particularly preferably 5 μm or more and 20 μm or less. By setting the average thickness of the negative electrode substrate in the above range, it is possible to enhance the energy density per volume of a secondary battery while increasing the strength of the negative electrode substrate.

The negative active material layer is generally formed of a so-called negative composite containing a negative active material. The negative composite forming the negative active material layer contains optional components such as a conductive agent, a binder, a thickener, a filler, or the like as necessary. As the optional components such as a conductive agent, a binder, a thickener, and a filler, the same components as those in the positive active material layer can be used. The conductive agent used for the negative active material layer may be one or both of a fibrous conductive agent and a granular conductive agent, and may be other conductive agent. The negative active material layer may be a layer substantially composed of only a negative active material such as metallic Li.

The negative active material layer may contain a typical nonmetal element such as B, N, P, F, Cl, Br, or I, a typical metal element such as Li, Na, Mg, Al, K, Ca, Zn, Ga, Ge, Sn, Sr, and Ba or a transition metal element such as Sc, Ti, V, Cr, Mn, Fe, Co, Ni, Cu, Mo, Zr, Ta, Hf, Nb, or W as a component other than the negative active material, the conductive agent, the binder, the thickener, and the filler.

The negative active material can be appropriately selected from known negative active materials. As the negative active material for a lithium ion secondary battery, a material capable of absorbing and releasing lithium ions is usually used. Examples of the negative active material include metallic Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, graphite and non-graphitic carbon are preferable. In the negative active material layer, one of these materials may be used singly, or two or more of these materials may be used in mixture.

The term “graphite” refers to a carbon material in which an average lattice spacing (d₀₀₂) of a (002) plane determined by an X-ray diffraction method before charge-discharge or in a discharged state is 0.33 nm or more and less than 0.34 nm. Examples of the graphite include natural graphite and artificial graphite. Artificial graphite is preferable from the viewpoint that a material having stable physical properties can be obtained.

The term “non-graphitic carbon” refers to a carbon material in which the average lattice spacing (d₀₀₂) of the (002) plane determined by the X-ray diffraction method before charge-discharge or in the discharged state is 0.34 nm or more and 0.42 nm or less. Examples of the non-graphitic carbon include hardly graphitizable carbon and easily graphitizable carbon. Examples of the non-graphitic carbon include a resin-derived material, a petroleum pitch or a material derived from petroleum pitch, a petroleum coke or a material derived from petroleum coke, a plant-derived material, and an alcohol derived material.

In this regard, the “discharged state” of the carbon material means a state discharged such that lithium ions that can be occluded and released in association with charge-discharge are sufficiently released from the carbon material that is the negative active material. For example, the “discharged state” refers to a state where an open circuit voltage is 0.7 V or higher in a half cell that has, for use as a working electrode, a negative electrode containing a carbon material as a negative active material, and has metal Li for use as a counter electrode.

The “hardly graphitizable carbon” refers to a carbon material in which the d₀₀₂ is 0.36 nm or more and 0.42 nm or less.

The “easily graphitizable carbon” refers to a carbon material in which the d₀₀₂ is 0.34 nm or more and less than 0.36 nm.

The negative active material is usually particles (powder). The average particle size of the negative active material can be, for example, 1 nm or more and 100 μm or less. When the negative active material is, for example, a carbon material, a titanium-containing oxide, or a polyphosphoric acid compound, the average particle size thereof may be 1 μm or more and 100 μm or less. When the negative active material is Si, Sn, an oxide of Si, an oxide of Sn, or the like, the average particle size thereof may be 1 nm or more and 1 μm or less. By setting the average particle size of the negative active material to be equal to or greater than the above lower limit, the negative active material is easily produced or handled. By setting the average particle size of the negative active material to be equal to or less than the above upper limit, the electron conductivity of the negative active material layer is improved. A crusher or a classifier is used to obtain a powder having a predetermined particle size. When the negative active material is metallic Li, the form may be foil-shaped or plate-shaped. The average particle size of the negative active material is a secondary particle size, and is a value measured according to the method for measuring the secondary particle size of the positive active material particle described above.

The content of the negative active material in the negative active material layer is preferably 60% by mass or more and 99% by mass or less, and more preferably 90% by mass or more and 98% by mass or less. When the content of the negative active material falls within the above range, it is possible to achieve both high energy density and productivity of the negative active material layer. When the negative active material is metallic Li, the content of the negative active material in the negative active material layer may be 99% by mass or more, and may be 100% by mass.

(Separator)

The separator can be appropriately selected from known separators. As the separator, for example, a separator composed of only a substrate layer, a separator in which a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, a porous resin film is preferable from the viewpoint of strength, and a nonwoven fabric is preferable from the viewpoint of liquid retaining property of the nonaqueous electrolyte. As the material of the substrate layer of the separator, a polyolefin such as polyethylene or polypropylene is preferable from the viewpoint of a shutdown function, and polyimide, aramid or the like is preferable from the viewpoint of resistance to oxidation and decomposition. As the substrate layer of the separator, a material obtained by combining these resins may be used.

The heat resistant particles included in the heat resistant layer preferably have a mass loss of 5% or less in the case of temperature increase from room temperature to 500° C. under the air atmosphere of 1 atm, and more preferably have a mass loss of 5% or less in the case of temperature increase from room temperature to 800° C. Inorganic compounds can be mentioned as materials whose mass loss is a predetermined value or less. Examples of the inorganic compounds include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite and mica, and artificial products thereof. As the inorganic compounds, a simple substance or a complex of these substances may be used alone, or two or more thereof may be used in mixture. Among these inorganic compounds, silicon oxide, aluminum oxide, or aluminosilicate is preferable from the viewpoint of safety of the secondary battery.

The porosity of the separator is preferably 80% by volume or less from the viewpoint of strength, and is preferably 20% by volume or more from the viewpoint of discharge performance. The term “porosity” herein is a volume-based value, and means a value measured with a mercury porosimeter.

As the separator, a polymer gel composed of a polymer and a nonaqueous electrolyte may be used. Examples of the polymer include polyacrylonitrile, polyethylene oxide, polypropylene oxide, polymethyl methacrylate, polyvinyl acetate, polyvinylpyrrolidone, and polyvinylidene fluoride. The use of the polymer gel has the effect of suppressing liquid leakage. As the separator, a polymer gel may be used in combination with a porous resin film, a nonwoven fabric, or the like as described above.

(Nonaqueous Electrolyte)

The nonaqueous electrolyte can be appropriately selected from known nonaqueous electrolytes. As the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, those in which some hydrogen atoms contained in these compounds are substituted with halogen may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these examples, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl)carbonate. Among these examples, DMC and EMC are preferable.

As the nonaqueous solvent, it is preferable to use at least one of the cyclic carbonate and the chain carbonate, and it is more preferable to use the cyclic carbonate and the chain carbonate in combination. By using the cyclic carbonate, dissociation of the electrolyte salt can be promoted to improve the ionic conductivity of the nonaqueous electrolyte solution. By using the chain carbonate, the viscosity of the nonaqueous electrolyte solution can be kept low. When the cyclic carbonate and the chain carbonate are used in combination, a volume ratio of the cyclic carbonate to the chain carbonate (cyclic carbonate:chain carbonate) is preferably in a range from 5:95 to 50:50, for example.

The electrolyte salt can be appropriately selected from known electrolyte salts. Examples of the electrolyte salt include a lithium salt, a sodium salt, a potassium salt, a magnesium salt, and an onium salt. Among these salts, the lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts having a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃. Among these salts, an inorganic lithium salt is preferable, and LiPF₆ is more preferable.

The content of the electrolyte salt in the nonaqueous electrolyte solution is, at 20° C. under 1 atm, preferably 0.1 mol/dm³ or more and 2.5 mol/dm³ or less, more preferably 0.3 mol/dm³ or more and 2.0 mol/dm³ or less, still more preferably 0.5 mol/dm³ or more and 1.7 mol/dm³ or less, and particularly preferably 0.7 mol/dm³ or more and 1.5 mol/dm³ or less. The content of the electrolyte salt falls within the above range, thereby allowing the ionic conductivity of the nonaqueous electrolyte solution to be increased.

The nonaqueous electrolyte solution may contain an additive, besides the nonaqueous solvent and the electrolyte salt. Examples of the additive include halogenated carbonic acid esters such as fluoroethylene carbonate (FEC) and clifluoroethylene carbonate (DFEC); oxalates such as lithium bis(oxalate)borate (LiBOB), lithium difluorooxalatoborate (LiFOB), and lithium bis(oxalate)difluorophosphate (LiFOP); imide salt such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and clibenzofuran; partial halides of the aromatic compounds such as 2-fluorobiphenyl, o-cyclohexylfluorobenzene, and p-cyclohexylfluorobenzene; halogenated anisole compounds such as 2,4-difluoroanisole, 2,5-clifluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexaneclicarboxylic anhydride; ethylene sulfite, propylene sulfite, dimethyl sulfite, dimethyl sulfate, ethylene sulfate, sulfolane, dimethyl sulfone, diethyl sulfone, dimethylsulfoxide, diethyl sulfoxide, tetramethylene sulfoxide, diphenyl sulfide, 4,4′-bis(2,2-clioxo-1,3,2-dioxathiolane), 4-methylsulfonyloxymethyl-2,2-dioxo-1,3,2-clioxathiolane, thioanisole, diphenyl disulfide, clipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. These additives may be used singly, or two or more thereof may be used in mixture.

The content of the additive contained in the nonaqueous electrolyte solution is preferably 0.01% by mass or more and 10% by mass or less, more preferably 0.1% by mass or more and 7% by mass or less, still more preferably 0.2% by mass or more and 5% by mass or less, and particularly preferably 0.3% by mass or more and 3% by mass or less, with respect to a total mass of the nonaqueous electrolyte solution. When the content of the additive falls within the above range, it is possible to improve capacity retention performance or charge-discharge cycle performance after high-temperature storage, and to further improve safety.

As the nonaqueous electrolyte, a solid electrolyte may be used, or a nonaqueous electrolyte solution and a solid electrolyte may be used in combination.

The solid electrolyte can be selected from any material having ionic conductivity such as lithium, sodium and calcium and being solid at normal temperature (for example, 15° C. to 25° C.). Examples of the solid electrolyte include sulfide solid electrolytes, oxide solid electrolytes, oxynitride solid electrolytes, and polymer solid electrolytes.

Examples of the lithium ion secondary battery include Li₂S—P₂S₅, LiI—Li₂S—P₂S₅, and Li₁₀Ge—P₂S₁₂ as the sulfide solid electrolyte.

In the secondary battery (energy storage device) of the present embodiment, the initial DC resistance is reduced while the single-particle-based positive active material particle is used. Therefore, the secondary battery can also be suitably applied to high-output applications. The secondary battery is suitably used as a power source for an automobile such as an electric vehicle (EV), a hybrid electric vehicle (HEV), or a plug-in hybrid electric vehicle (PHEV) as a high-output application.

The shape of the secondary battery of the present embodiment is not particularly limited, and examples thereof include cylindrical batteries, prismatic batteries, flat batteries, coin batteries and button batteries.

The secondary battery (energy storage device) can be produced, for example, by a production method including preparing a positive electrode, preparing a negative electrode, preparing a nonaqueous electrolyte, forming an electrode assembly in which the positive electrode and the negative electrode are alternately superposed by stacking or winding the positive electrode and the negative electrode with a separator interposed between the electrodes, housing the positive electrode and the negative electrode (electrode assembly) in a case, and injecting the nonaqueous electrolyte into the case. The secondary battery can be obtained by sealing an injection port after the injection.

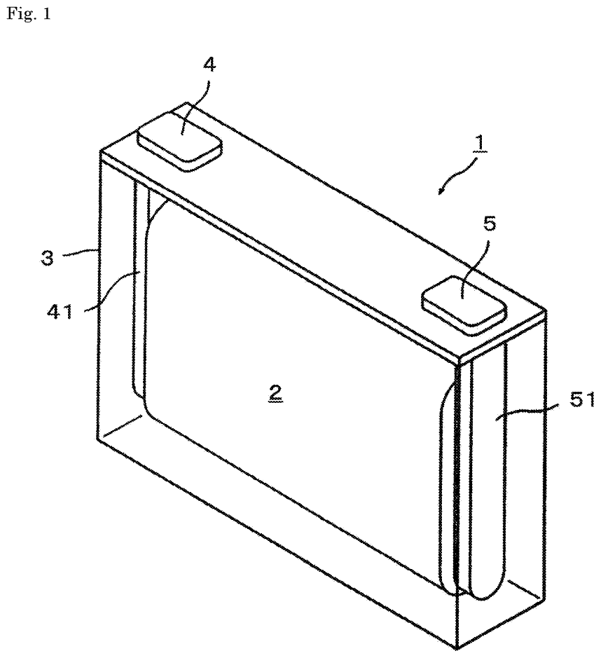

FIG. 1 shows an energy storage device 1 as an example of a prismatic battery. FIG. 1 is a view showing an inside of a case in a perspective manner. An electrode assembly 2 having a positive electrode and a negative electrode which are wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

<Configuration of Energy Storage Apparatus>

The energy storage device of the present embodiment can be mounted as an energy storage unit (battery module) configured by assembling a plurality of energy storage devices 1 on a power source for automobiles such as electric vehicles (EV), hybrid vehicles (HEV), and plug-in hybrid vehicles (PHEV), a power source for electronic devices such as personal computers and communication terminals, or a power source for power storage, or the like. In this case, the technique according to an embodiment of the present invention may be applied to at least one energy storage device included in the energy storage unit.

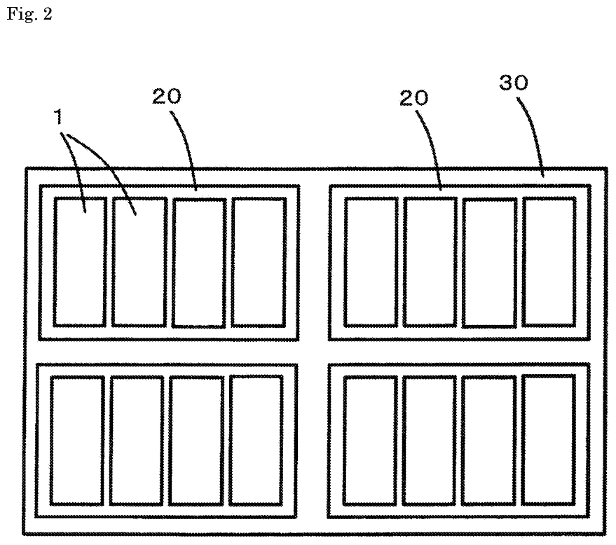

FIG. 2 illustrates an example of an energy storage apparatus 30 formed by assembling energy storage units 20 in each of which two or more electrically connected energy storage devices 1 are assembled. The energy storage apparatus 30 may include a busbar (not illustrated) for electrically connecting two or more energy storage devices 1, a busbar (not illustrated) for electrically connecting two or more energy storage units 20, and the like. The energy storage unit 20 or the energy storage apparatus 30 may include a state monitor (not illustrated) for monitoring the state of one or more energy storage devices.

<Other Embodiments>

The present invention is not limited to the above embodiments, and various modifications may be made without departing from the gist of the present invention. For example, to the configuration of an embodiment, the configuration of another embodiment can be added, and a part of the configuration of an embodiment can be replaced by the configuration of another embodiment or a well-known technique. Furthermore, a part of the configuration according to one embodiment can be removed. In addition, a well-known technique can be added to the configuration according to one embodiment.

In the above embodiment, although the case where the energy storage device is used as a nonaqueous electrolyte secondary battery (for example, lithium ion secondary battery) that can be charged and discharged has been described, the type, shape, size, capacity, and the like of the energy storage device are arbitrary. The positive electrode and the energy storage device of the present invention can also be applied to capacitors such as various nonaqueous electrolyte secondary batteries, electric double layer capacitors, and lithium ion capacitors. Also, the positive electrode and the energy storage device of the present invention can also be applied to an energy storage device in which the electrolyte is an electrolyte other than the nonaqueous electrolyte.

### EXAMPLES

Hereinafter, the present invention will be described in more detail with reference to examples, but the present invention is not limited to the following examples.

(Evaluation 1) Initial DC Resistance

The positive active material particles used are shown below.

Positive active material particle A: LiNi_{0.6}Co_{0.2}Mn_{0.2}O₂ particle as a positive active material

Primary particle size: 4 μm, secondary particle size: 4 μm, secondary particle size/primary particle size=1

(positive active material particle existing in a state of substantially non-aggregated primary particles)

Positive active material particle B: LiNi_{0.6}Co_{0.2}Mn_{0.2}O₂ particle as a positive active material

Primary particle size: 0.5 μm, secondary particle size: 4 μm, secondary particle size/primary particle size=8

### Example 1-1

(Preparation of Positive Electrode)

The positive active material particle A as a positive active material particle, a fibrous conductive agent and carbon black (CB) as conductive agents, and polyvinylidene fluoride (PVDF) as a binder were used. An appropriate amount of N-methyl-pyrrolidone (NMP) was added to a mixture in which the mass ratio of the positive active material particle A, the fibrous conductive agent, CB and the binder was set to 93:0.5:4.0:2.5 to adjust the viscosity, thereby preparing a positive composite paste. The positive composite paste was applied onto the surface of an aluminum foil, and was dried to prepare a positive active material layer. Thereafter, roll pressing was performed to obtain a positive electrode of Example 1-1.

As the fibrous conductive agent, a CNT having an average diameter of 20 nm and an average length of about 60 to 100 μm was used.

(Preparation of Negative Electrode)

A negative composite paste was produced, which contained graphite as a negative active material, styrene butadiene rubber (SBR), and carboxymethyl cellulose (CMC) at a ratio of 96:3:1 (in terms of solid content) with water as a dispersion medium. The negative composite paste was applied to the surface of a copper foil and dried to prepare a negative active material layer. Thereafter, roll pressing was performed to obtain a negative electrode.

(Assembly of Secondary Battery)

A secondary battery (energy storage device) using the positive electrode and the negative electrode was assembled. As a nonaqueous electrolyte, a solution obtained by dissolving lithium hexafluorophosphate (LiPF₆) as an electrolyte salt at a concentration of 1.0 mol/dm³ in a nonaqueous solvent obtained by mixing EC (ethylene carbonate), EMC (ethylmethyl carbonate), and dimethyl carbonate (DMC) at a volume ratio of 30:35:35 was used, and a polyolefin microporous membrane was used as a separator.

### Comparative Example 1-1

A positive electrode and an energy storage device of Comparative Example 1-1 were prepared similarly to Example 1-1 except that the fibrous conductive agent was not used and the mass ratio of the positive active material particle A, CB and the binder was set to 93:4.5:2.5.

### Reference Example 1-1

A positive electrode and an energy storage device of Reference Example 1-1 were prepared similarly to Example 1-1 except that the positive active material particle B was used as the positive active material particle.

### Reference Example 1-2

A positive electrode and an energy storage device of Reference Example 1-2 were prepared similarly to Reference Example 1-1 except that the fibrous conductive agent was not used, and the mass ratio of the positive active material particles B, CB and the binder was set to 93:4.5:2.5.

### [Evaluation]

(Initial DC Resistance)

The obtained energy storage devices were subjected to constant current charge at 1.0 C at 25° C. to adjust the SOC to 50%, and then discharged at 25° C. for 30 seconds at each current of 0.2 C, 0.5 C, and 1.0 C in this order. The relationship between the current at each discharge current and the voltage at 10 seconds after the start of discharge was plotted, and the initial DC resistance (initial DCR) was determined from the slope of a straight line obtained from the plot of 3 points. The measurement results are shown in Table 1. Also, in order to show an improvement effect by the fibrous conductive agent, Table 1 shows a relative value of the initial DC resistance of Example 1-1 using the fibrous conductive agent based on Comparative Example 1-1 not using the fibrous conductive agent, and a relative value of the initial DC resistance of Reference Example 1-1 using the fibrous conductive agent based on Reference Example 1-2 not using the fibrous conductive agent.

TABLE 1

| | | Fibrous | Initial DCR | |
|---|---|---|---|---|
| | Positive active material particle | conductive agent | | Relative value |
| Example 1-1 | Type | Present or absent | (Ω) | (%) |
| Comparative | A | Present | 1.597 | 40.2 |
| Example 1-1 | (Secondary particle size/ | | | |
| Comparative | primary particle size = 1) | Absent | 3.975 | — |
| Example 1-1 | | | | |
| Reference | B | Present | 1.517 | 89.5 |
| Example 1-1 | (Secondary particle size/ | | | |
| Reference | primary particle size = 8) | Absent | 1.695 | — |
| Example 1-2 | | | | |

From a comparison between Example 1-1 and Comparative Example 1-1, it is found that the initial DC resistance is greatly reduced by using the fibrous conductive agent in combination for the single-particle-based positive active material particle A. On the other hand, from a comparison between Reference Example 1-1 and Reference Example 1-2, in the case of the positive active material particle B that is not a single-particle-based, even when a fibrous conductive agent is used, an effect of reducing the initial DC resistance is very small. It can be said that the effect of greatly reducing the initial DC resistance is a remarkable effect that occurs only when the single-particle-based positive active material particle and the fibrous conductive agent are combined.

(Evaluation 2) DC Resistance Increase Rate After Charge-Discharge Cycle

The positive active material particles used are shown below.

Positive active material particle C:LiNi_{0.6}Co_{0.2}Mn_{0.2}O₂ particle as a positive active material

Primary particle size: 5.0 μm, secondary particle size: 5.1 μm, secondary particle size/primary particle size=1.0

(positive active material particle existing in a state of substantially non-aggregated primary particles)

Positive active material particle D:LiNi_{0.6}Co_{0.2}Mn_{0.2}O₂ particle as a positive active material

Primary particle size: 0.6 μm, secondary particle size: 8.5 μm, secondary particle size/primary particle size=14

### Example 2-11

(Preparation of Positive Electrode)

The positive active material particle C as a positive active material particle, a CNT (average diameter of 7 nm, average length of about 60 to 100 μm) as a fibrous conductive agent, carbon black (CB: average particle size of 35 nm, average aspect ratio of 1.1) as a granular conductive agent, and polyvinylidene fluoride (PVDF) as a binder were used. An appropriate amount of N-methyl-pyrrolidone (NMP) was added to a mixture in which the mass ratio of the positive active material particle C, CNT, CB and the binder was set to 94.5:1:3:1.5 to adjust the viscosity, thereby preparing a positive composite paste. The positive composite paste was applied onto the surface of an aluminum foil, and was dried to prepare a positive active material layer. Thereafter, roll pressing was performed to obtain a positive electrode of Example 2-1.

(Preparation of Negative Electrode)

A negative composite paste was produced, which contained graphite as a negative active material, styrene butadiene rubber (SBR), and carboxymethyl cellulose (CMC) at a ratio of 96:3:1 (in terms of solid content) with water as a dispersion medium. The negative composite paste was applied to the surface of a copper foil and dried to prepare a negative active material layer. Thereafter, roll pressing was performed to obtain a negative electrode.

(Assembly of Secondary Battery)

A secondary battery (energy storage device) using the positive electrode and the negative electrode was assembled. As a nonaqueous electrolyte, a solution obtained by dissolving lithium hexafluorophosphate (LiPF₆) as an electrolyte salt at a concentration of 1.0 mol/dm³ in a nonaqueous solvent obtained by mixing EC (ethylene carbonate), EMC (ethylmethyl carbonate), and dimethyl carbonate (DMC) at a volume ratio of 30:35:35 was used, and a polyolefin microporous membrane was used as a separator.

### Example 2-2, Example 2-3

Positive electrodes and energy storage devices of Example 2-2 and Example 2-3 were prepared similarly to Example 1-1 except that the mass ratio of CNT to CB was set to as shown in Table 2.

### Example 2-4

A positive electrode and an energy storage device of Example 2-4 were prepared similarly to Example 2-1 except that the mass ratio of the positive active material C, CNT, CB and the binder was set to 93.5:1:4:1.5.

### Comparative Example 2-1

A positive electrode and an energy storage device of Comparative Example 2-1 were prepared similarly to Example 2-1 except that CNT was not used and the mass ratio of the positive active material particle C, CB and the binder was set to 93:4:3.

### Comparative Example 2-2

A positive electrode and an energy storage device of Comparative Example 2-2 were prepared similarly to Example 2-1 except that CNT was not used and the mass ratio of the positive active material particle C, CB and the binder was set to 89.5:6:4.5.

### Reference Example 2-1

A positive electrode and an energy storage device of Reference Example 2-1 were prepared similarly to Example 2-1 except that CB was not used and the mass ratio of the positive active material particle C, CNT and the binder was set to 96.5:2:1.5.

### Reference Example 2-2

A positive electrode and an energy storage device of Reference Example 2-1 were prepared similarly to Comparative Example 2-1 except that the positive active material particle D was used as the positive active material particle, and the mass ratio of the positive active material particle B, CB and the binder was set to 94.5:4:1.5.

### Reference Example 2-3

A positive electrode and an energy storage device of Reference Example 2-2 were prepared similarly to Example 2-1 except that the positive active material particle D was used as the positive active material particle, and the mass ratio of the positive active material particle B, CNT, CB and the binder was set to 94.5:1:3:1.5.

### [Evaluation]

(Initial DC resistance)

The obtained energy storage devices were subjected to constant current charge at 1.0 C at 25° C. to adjust the SOC to 50%, and then discharged at 25° C. for 30 seconds at each current of 0.2 C, 0.5 C, and 1.0 C in this order. The relationship between the current at each discharge current and the voltage at 10 seconds after the start of discharge was plotted, and the DC resistance (initial DC resistance) was determined from the slope of a straight line obtained from the plot of 3 points.

(Charge-Discharge Cycle Test)

Subsequently, the following charge-discharge cycle test was performed. At 60° C., constant current constant voltage charge was performed at a charge current of 1.0 C and an end-of-charge voltage of 4.20 V. With regard to the charge termination conditions, charge was performed until the total charge time reached 3 hours. Thereafter, a pause time of 10 minutes was provided. Constant current discharge was performed at a discharge current of 1.0 C and an end-of-discharge voltage of 2.50 V, and then a pause time of 10 minutes was provided. This charge-discharge was performed 300 cycles.

(DC Resistance Increase Rate)

After the charge-discharge cycle test, the DC resistance (DC resistance after the charge-discharge cycle test) of each energy storage device was determined in the same manner as in the above “Initial DC resistance”. The DC resistance increase rate after the charge-discharge cycle test was obtained by dividing a difference between the DC resistance after the charge-discharge cycle test and the initial DC resistance by the initial DC resistance. The DC resistance increase rate (DCR increase rate) is shown in Table 2.

In order to show an improvement effect by using CNT as a fibrous conductive agent and CB as a granular conductive agent in combination, Table 2 also shows a difference in DCR increase rate (%) from Comparative Example 2-1 or Reference Example 2-2. A case in which the DCR increase rate (%) decreases is shown as “−”, and a case in which the DCR increase rate (%) increases is shown as “+”.

TABLE 2

| | | | | | Difference in DCR increase rate (%) |
|---|---|---|---|---|---|
| | | | | DCR increase | from Comparative Example 2-1 or |
| | Positive active material particle | CNT | CB | rate | Reference Example 2-1 |
| | Type | % by mass | % by mass | % | % |
| Comparative | C | 0 | 4 | 41 | — |
| Example 2-1 | (Secondary particle size/ | | | | |
| Comparative | primary particle size = 1.0) | 0 | 6 | 32 | −9 |
| Example 2-2 | | | | | |
| Reference | | 2 | 0 | 126 | 85 |
| Example 2-1 | | | | | |
| Example 2-1 | | 1 | 3 | 24 | −17 |
| Example 2-2 | | 1.5 | 2.5 | 21 | −20 |
| Example 2-3 | | 2 | 2 | 15 | −26 |
| Example 2-4 | | 1 | 4 | 18 | −23 |
| Reference | D | 0 | 4 | 38 | — |
| Example 2-2 | (Secondary particle size/ | | | | |
| Reference | primary particle size = 14) | 1 | 3 | 32 | −6 |
| Example 2-3 | | | | | |

From a comparison among Comparative Example 2-1 and Example 2-1 to Example 2-4, it is found that the DC resistance increase rate after the charge-discharge cycle test is significantly reduced by using CNT as a fibrous conductive agent and CB as a granular conductive agent in combination for the single-particle-based positive active material particle C. On the other hand, in Comparative Example 2-2 in which the amount of CB was increased as compared with Comparative Example 2-1, an effect of reducing the DC resistance increase rate was low, and in Reference Example 2-1 in which only CNT was used as the conductive agent, the DC resistance increase rate was increased as compared with Comparative Example 2-1. From a comparison between Reference Example 2-2 and Reference Example 2-3, in the case of the positive active material particle D which is not a single-particle-based, the effect of reducing the DC resistance increase rate when CNT and CB are used in combination was low. Furthermore, from a comparison among Example 2-1 to Example 2-4 and Reference Example 2-3, it was found that when CNT and CB were used in combination for the single-particle-based positive active material particle C, the DC resistance increase rate was reduced lower than that when CNT and CB were used in combination for the non-single-particle-based positive active material particle D. It can be said that the effect of greatly reducing the DC resistance increase rate after the charge-discharge cycle test is a remarkable effect that occurs for the first time when the fibrous conductive agent and the granular conductive agent are used in combination for the single-particle-based positive active material particle.

In addition, comparing Example 2-1 to Example 2-3 in which the total contents of the fibrous conductive agent and the granular conductive agent are equal in Examples, it is found that as the content ratio of the fibrous conductive agent is higher in Examples, the effect of reducing the DC resistance increase rate after the charge-discharge cycle test is enhanced, probably because the mixing ratio is optimized.

### INDUSTRIAL APPLICABILITY

The present invention can be applied to a nonaqueous electrolyte energy storage device used as a power source for electronic devices such as personal computers and communication terminals, automobiles, and the like, and a positive electrode and the like provided in the nonaqueous electrolyte energy storage device.

### DESCRIPTION OF REFERENCE SIGNS

1: energy storage device

2: electrode assembly

3: case

4: positive electrode terminal

41: positive electrode lead

5: negative electrode terminal

51: negative electrode lead

20: energy storage unit

30: energy storage apparatus

1. A positive electrode for an energy storage device, comprising a positive active material layer, wherein
the positive active material layer includes a positive active material particle having a ratio of a secondary particle size to a primary particle size of 3 or less, and a fibrous conductive agent.

2. A positive electrode for an energy storage device, comprising a positive active material layer, wherein
the positive active material layer includes a positive active material particle existing in a state of substantially non-aggregated primary particles, and a fibrous conductive agent.

3. The positive electrode according to claim 1, wherein the positive active material layer further includes a granular conductive agent.

4. The positive electrode according to claim 1, wherein the fibrous conductive agent and the granular conductive agent are carbonaceous materials.

5. The positive electrode according to claim 1, wherein the fibrous conductive agent has an average diameter of 100 nm or less.

6. The positive electrode according to claim 1, wherein a content of the fibrous conductive agent in the positive active material layer is 3% by mass or less.

7. The positive electrode according to claim 3, wherein a content of the fibrous conductive agent with respect to a total content of the fibrous conductive agent and the granular conductive agent in the positive active material layer is 30% by mass or more and 70% by mass or less.

8. The positive electrode according to claim 1, wherein the positive active material particle is a lithium transition metal composite oxide having an α-NaFeO₂-type crystal structure.

9. An energy storage device comprising the positive electrode according to claim 1.
